(19) United States
(12) Patent Application Publication
(10) Pub. No.: US 2007/0136734 A1
(43) Pub. Date: Jun. 14, 2007

(54) Electronic apparatus having antistatic function

(75) Inventors: Takuya Sasaki, Echizen-city (JP); Kazuyuki Shimizu, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/636,957

(22) Filed: Dec. 12, 2006

(30) Foreign Application Priority Data
Dec. 13, 2005 (JP) 2005-359396

(51) Int. Cl. G11B 33/02

(52) U.S. Cl. 720/646

(57) ABSTRACT

The invention provides an electronic apparatus that discharges static electricity built up on a decorative panel to a ground portion with reliability without degrading the appearance design. A bent portion of a connecting member is interposed between a decorative panel and a nameplate, and the nameplate is fixed to the decorative panel. Thereby, the bent portion is pinched between the decorative panel and the nameplate, being in elastic contact with a conductive coating layer of the decorative panel, and a curved portion extending from the bent portion makes elastic contact with a front plate as a ground portion, thus discharging static electricity built up on the conductive coating layer to the front plate through the connecting member.

The present application is based on and claims priority of Japanese patent application No. 2005-359396 filed on Dec. 13, 2005, the entire contents of which are hereby incorporated by reference.

### BACKGROUND OF THE INVENTION

1. Field of the Invention

The present invention relates to an electronic apparatus having the antistatic function of discharging static electricity built up on a decorative panel mounted to the front surface of an enclosure and thereby protecting electronic circuits and the like, in a disk apparatus and an audio apparatus such as a DVD player and a CD player, or an electronic apparatus such as a television receiver, a liquid crystal display, a plasma display, and a rear projector.

2. Description of the Related Art

In the past, there have been cases where a decorative panel subjected to decorative plating, a half mirror, or the like for design enhancement is provided at the front surface of an enclosure in a disk apparatus and an audio apparatus such as a DVD player and a CD player, or an electronic apparatus such as a television receiver, a liquid crystal display, a plasma display, and a rear projector. Such a decorative panel subjected to a vapor deposition layer as a half mirror or a plating layer easily becomes electrostatically charged, and static electricity built up on the decorative panel may adversely affect internal electronic components. As a measure against static electricity built up on the decorative panel, for example, Japanese Patent Laid-Open Publication No. 2002-368436 (patent document 1) proposes an electronic apparatus in which a plated operation section is fixed to a plated decorative panel at the rear surface by a conductive screw and the head of the screw is brought into contact with the ground portion of a circuit board so that static electricity built up on the decorative panel is discharged to the ground portion of the circuit board through the operation section and the screw.

However, in the electronic apparatus described in patent document 1, the entire decorative panel including the front side and back side is covered with a plating layer, and static electricity is discharged to the ground portion of the circuit board with the screw screwed into the back side of the decorative panel. For this reason, in the case where a vapor deposition layer, a plating layer or the like is applied only to the front side of the decorative panel, it is necessary to screw a screw into a conductive coating layer applied to the front side of the decorative panel and cause the screw to make contact with the ground portion at the back side of the decorative panel. Such a method has the following problems. The screw exposed to the front side of the decorative panel does not make good appearance. In addition, depending on variations in the length of the screw protruding through the back side of the decorative panel, the screw is pressed hard against the ground portion, or a contact pressure between the screw and the ground portion is low so that static electricity built up on the decorative panel cannot be effectively discharged.

### SUMMARY OF THE INVENTION

The present invention has been made in view of the above problems, and it is a first object of the invention to provide an electronic apparatus that can discharge static electricity built up on a decorative panel to a ground portion without degrading the appearance design. Further, it is a second object of the invention to provide an electronic apparatus that can allow a connecting member to make contact with the ground portion with reliability and stability.

An electronic apparatus having an antistatic function of a first aspect includes a decorative panel which is placed at a front surface of an enclosure, with a conductive coating layer applied to at least a part of a surface of the decorative panel; a nameplate which is fixed to a front surface of the conductive coating layer; a ground portion which is provided in the enclosure; and a connecting member with which the conductive coating layer makes electric contact with the ground portion, wherein the connecting member is provided with a mounting portion and a contact portion, the mounting portion being in contact with the conductive coating layer and pinched between the decorative panel and the nameplate, the contact portion extending through the decorative panel from the mounting portion and making contact with the ground portion.

In accordance with the structure of the first aspect, the mounting portion of the connecting member is pinched between the decorative panel and the nameplate, being in contact with the conductive coating layer, and the contact portion extending from the mounting portion makes contact with the ground portion. Thereby, static electricity built up on the conductive coating layer of the decorative panel is discharged to the ground portion through the connecting member.

According to an electronic apparatus having an antistatic function of a second aspect, in the electronic apparatus having an antistatic function according to aspect 1, the connecting member has flexibility, and the connecting member is provided with a bent portion as the mounting portion and the contact portion, the bent portion being pinched between the decorative panel and the nameplate and elastically deformed, the contact portion extending from the bent portion and making elastic contact with the ground portion.

In accordance with the structure of the second aspect, the bent portion pinched between the decorative panel and the nameplate makes elastic contact with the conductive coating layer by the elastic restoring force of the connecting member, and the contact portion makes elastic contact with the ground portion, so that static electricity built up on the conductive coating layer of the decorative panel is discharged to the ground portion through the connecting member.

According to an electronic apparatus having an antistatic function of a third aspect, in the electronic apparatus having an antistatic function according to aspect 2, there is formed, on the rear surface of the nameplate, a recess for accommodating the bent portion elastically deformed.

In accordance with the structure of the third aspect, the bent portion pinched between the decorative panel and the nameplate is accommodated in the recess, so that the nameplate is not lifted from the decorative panel.

According to an electronic apparatus having an antistatic function of a fourth aspect, in the electronic apparatus having an antistatic function according to any one of aspects 1 through 3, a mounting boss is integrally formed on the nameplate, and a mounting hole corresponding to the mounting boss is formed in the decorative panel.

In accordance with the structure of the fourth aspect, when the nameplate is fixed to the decorative panel by press-fitting the mounting boss of the nameplate into the mounting hole in the decorative panel, the mounting portion of the connecting member is pinched between the nameplate and the decorative panel, thus making it possible to fix the connecting member to the decorative panel.

### BRIEF DESCRIPTION OF THE DRAWINGS

FIG. 1 is a plan sectional view showing a mounting state of a connecting member, according to an embodiment of the present invention;

FIG. 2 is a rear view of a nameplate;

FIG. 3 is a perspective view of the connecting member;

FIG. 4 is a longitudinal sectional view showing a state observed before the connecting member is mounted; and

FIG. 5 is a longitudinal sectional view showing a state observed after the connecting member is mounted.

### DETAILED DESCRIPTION OF THE PREFERRED EMBODIMENTS

A specific embodiment of the present invention will be described with reference to the attached drawings. The embodiment below is merely an example for implementing the invention and not intended to limit the invention.

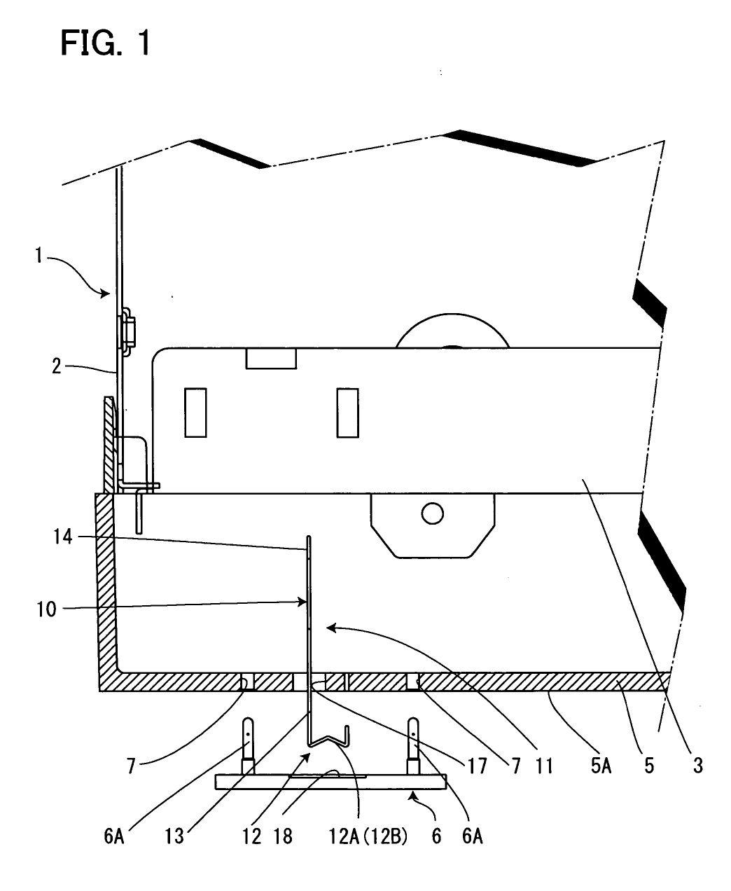

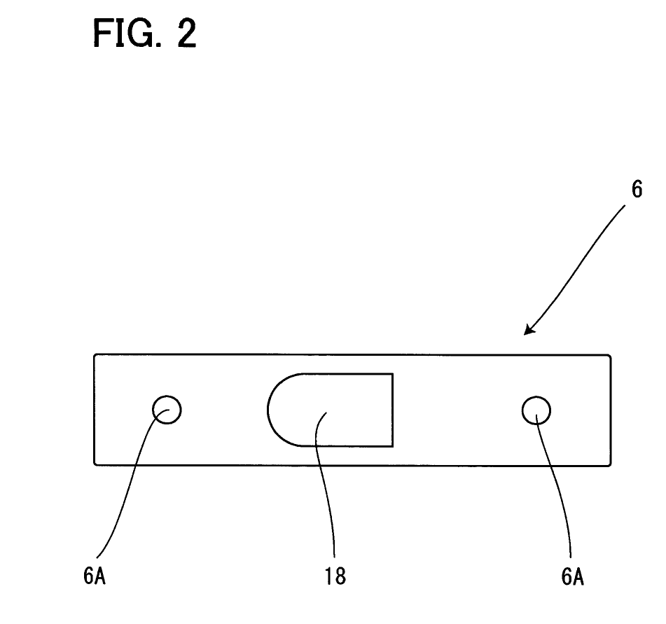

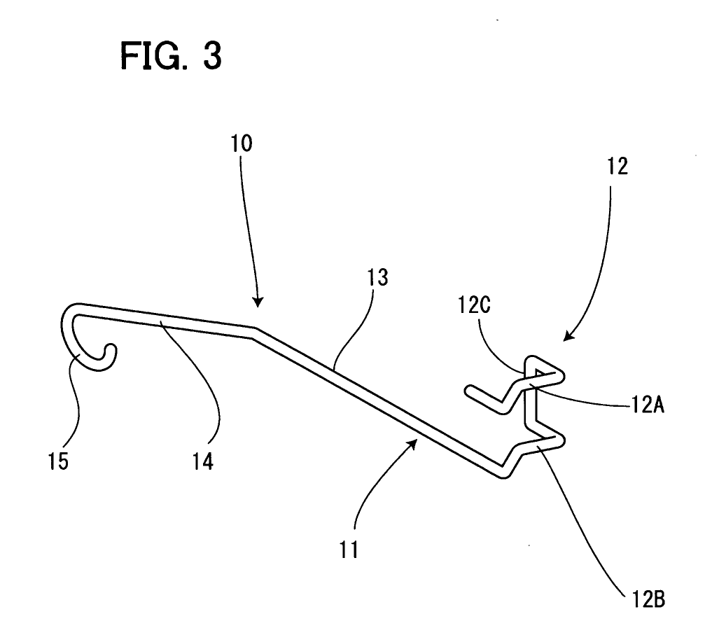

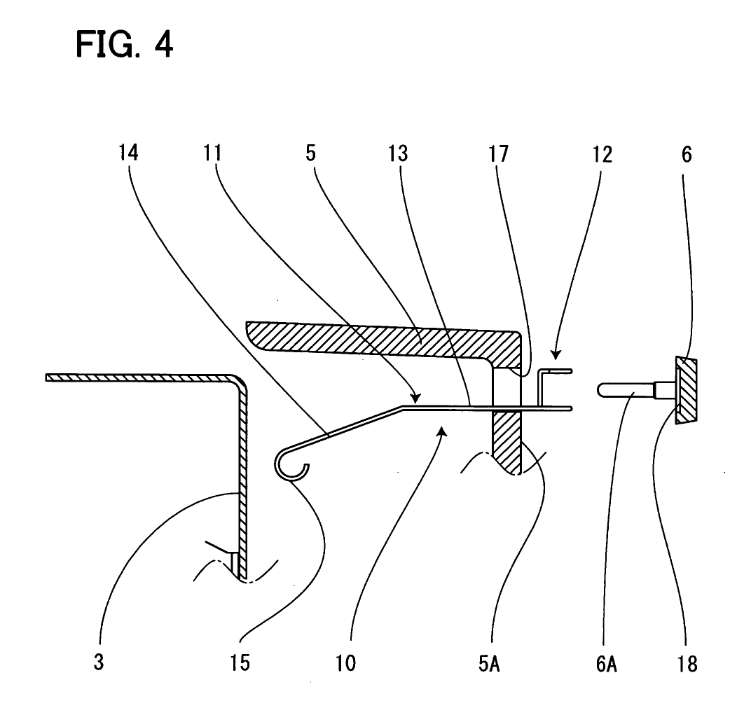

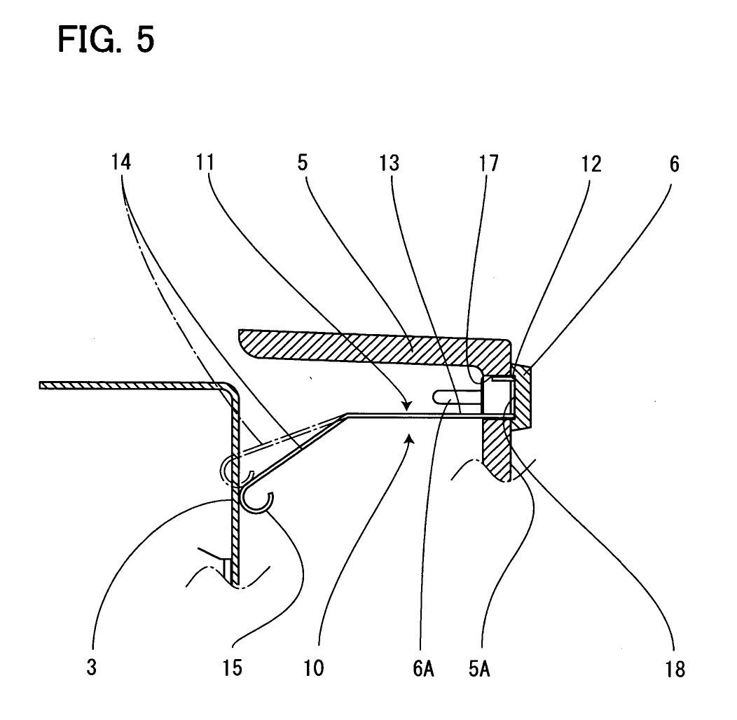

FIGS. 1 to 5 show an embodiment of the invention. FIG. 1 is a plan sectional view showing a mounting state of a connecting member. FIG. 2 is a rear view of a nameplate. FIG. 3 is a perspective view of the connecting member. FIGS. 4 and 5 are longitudinal sectional views showing mounting states of the connecting member. FIG. 4 shows a state observed before the connecting member is mounted. FIG. 5 shows a state observed after the connecting member is mounted. Description will be made of a case where this embodiment is applied to a recording/reproducing apparatus with a storage medium such as a disk as an example of an electronic apparatus. An enclosure 2 for enclosing a recording/reproducing apparatus 1 is formed by bending a conductive metal sheet, and a front plate 3 is provided at the front side of the enclosure 2. The front plate 3 and the enclosure 2 are bent in one piece from the bottom of the enclosure 2 so as to be at the same potential, or the separate front plate 3 is integrally fixed to the enclosure 2, being in contact with the enclosure 2, so that the front plate 3 functions as a ground portion.

Reference numeral 5 denotes a frame-like decorative panel facing the front plate 3 and covering the front surface of the enclosure 2. The decorative panel 5 is molded out of synthetic resin such as plastic. A conductive coating layer 5A such as a plating layer is formed on the front surface of the decorative panel 5 for the purpose of elaborating the design. On the decorative panel 5, there is mounted a circuit board where a variety of operation switches and a display section such as an LCD (not shown) are disposed. Corresponding to the operation switches and the display section, operation buttons and a display window (not shown) are formed, and a nameplate 6 indicating a manufacturer or a product name is mounted. The nameplate 6 is molded out of synthetic resin, for example. A pair of mounting bosses 6A is integrally formed on the rear surface of the nameplate 6 to fix the nameplate 6 to the decorative panel 5. The bosses 6A are fixed in mounting holes 7 formed in the decorative panel 5 by an appropriate means such as press fitting, welding or hooking, thus fixing the nameplate 6 to the decorative panel 5.

Reference numeral 10 denotes a connecting member for electrically connecting the conductive coating layer 5A on the decorative panel 5 to the front plate 3. The connecting member 10 is formed of a flexible wire rod 11. A bent portion 12 as a mounting portion is formed at one end of the wire rod 11. Further, there is provided a linear portion 13 linearly extending toward the front plate 3 through the decorative panel 5 from the bent portion 12, and there is provided an inclined portion 14 inclining downwardly from the leading end of the linear portion 13. At the leading end of the inclined portion 14, a curved portion 15 shaped like an arc is formed to make contact with the front plate 3. Further, in the decorative panel 5, an opening 17 is formed at a position hidden by the nameplate 6 so that the curved portion 15 can be inserted into it. On the rear surface of the nameplate 6, a recess 18 is formed to accommodate the bent portion 12. As shown in FIG. 3, the bent portion 12 accommodated in the recess 18 is composed of a pair of top and bottom M-shaped flexible bent portions 12A and 12B bent laterally from the linear portion 13, and a riser portion 12C for connecting one ends of the flexible bent portions 12A and 12B. The flexible bent portions 12A and 12B and the riser portion 12C are pinched between the nameplate 6 and the decorative panel 5, and thereby accommodated within the recess 18.

In this embodiment constructed as described above, as shown in FIGS. 1 and 4, after the curved portion 15 formed at the leading end of the connecting member 10 is inserted into the opening 17 formed in the decorative panel 5, the bosses 6A formed on the rear surface of the nameplate 6 are fixed in the holes 7 formed in the decorative panel 5 by an appropriate means such as press fitting, welding, or hooking. Thereby, as shown in FIG. 5, the bent portion 12 formed at one end of the connecting member 10 is pinched between the nameplate 6 and the decorative panel 5, and the flexible bent portions 12A and 12B and the riser portion 12C of the bent portion 12 are accommodated within the recess 18 in an elastically deformed state so as to be folded by the nameplate 6. Consequently, by the elastic restoring force of the flexible bent portions 12A and 12B and the riser portion 12C accommodated within the recess 18, the flexible bent portions 12A and 12B and the riser portion 12C make elastic contact with the conductive coating layer 5A formed on the front surface of the decorative panel 5. Further, the curved portion 15 of the connecting member 10 passing through the opening 17 is pressed by the nameplate 6, thereby bending the inclined portion 14 downward so that the curved portion 15 makes elastic contact with the front plate 3 by the elastic restoring force of the inclined portion 14. Thus, since the connecting member 10 is pinched between the decorative panel 5 and the nameplate 6, being in elastic contact with the conductive coating layer 5A applied to the front surface of the decorative panel 5 and the front plate 3 as a ground portion, static electricity built up on the conductive coating layer 5A of the decorative panel 5 can be discharged to the front plate 3 through the connecting member 10 with reliability.

Further, since the connecting member 10 is hidden behind the nameplate 6 mounted on the decorative panel 5 and not exposed to the outside in appearance, static electricity built up on the conductive coating layer 5A of the decorative panel 5 can be discharged to the front plate 3 with reliability without degrading the appearance design. Furthermore, it is not necessary to use a screw or the like to fix the connecting member 10, thereby simplifying the assembly operation. Since the connecting member 10 is fixed using the nameplate 6 mounted on the decorative panel 5, it is not necessary to add a new assembly part for fixing the connecting member 10, thereby reducing the assembly parts count and improving the efficiency of the assembly operation. Furthermore, since the recess 18 is formed on the rear surface of the nameplate 6 to accommodate the flexible bent portions 12A and 12B and the riser portion 12C of the elastically deformed bent portion 12, the nameplate 6 is not lifted from the decorative panel 5, thus making it possible to fix it neatly without a sense of incongruity in terms of design.

While an embodiment of the invention has been described in detail, the invention is not limited thereto and can be modified in various ways without departing from the spirit of the invention. For example, in the above-described embodiment, the recording/reproducing apparatus 1 is illustrated as an example of an electronic apparatus. However, the embodiment is not limited to the recording/reproducing apparatus 1 and can be applied to various kinds of electronic apparatuses such as an audio apparatus, a television receiver, a liquid crystal display, a plasma display, and a rear projector. Further, the embodiment shows an example in which the wire rod 11 is bent to be formed as a connecting member. However, the connecting member may be any other member such as a plate spring of a flexible metal sheet or a torsion spring as long as it has a structure capable of making elastic contact with the conductive coating layer and the ground portion by the elastic restoring force. Furthermore, the material of the connecting member is not limited to metal, and the connecting member may be molded out of conductive resin or the like. The shape, material, and the like of the connecting member can be selected as appropriate. Furthermore, the basic structure of the recording/reproducing apparatus 1 as an electronic apparatus, the shape or structure of the ground portion, the mounting structure of the nameplate, and the like are not limited to the embodiment described above and can be selected as appropriate.

The effects of the present invention are as follows.

The electronic apparatus having an antistatic function of aspect 1 includes a decorative panel which is placed at a front surface of an enclosure, with a conductive coating layer applied to at least a part of a surface of the decorative panel; a nameplate which is fixed to a front surface of the conductive coating layer; a ground portion which is provided in the enclosure; and a connecting member with which the conductive coating layer makes electric contact with the ground portion, wherein the connecting member is provided with a mounting portion and a contact portion, the mounting portion being in contact with the conductive coating layer and pinched between the decorative panel and the nameplate, the contact portion extending through the decorative panel from the mounting portion and making contact with the ground portion. Thus, the connecting member is hidden behind the nameplate mounted on the decorative panel, so that without sacrificing the appearance design, static electricity built up on the conductive coating layer can be discharged to the ground portion with reliability. Further, since the connecting member is fixed using the nameplate mounted on the decorative panel, it is not necessary to add a new assembly part for fixation, thereby reducing the assembly parts count and improving the efficiency of the assembly operation.

According to the electronic apparatus having an antistatic function of aspect 2, in the electronic apparatus having an antistatic function according to aspect 1, the connecting member has flexibility, and the connecting member is provided with a bent portion as the mounting portion and the contact portion, the bent portion being pinched between the decorative panel and the nameplate and elastically deformed, the contact portion extending from the bent portion and making elastic contact with the ground portion. Thus, the elastic restoring force of the connecting member enables the bent portion and the contact portion to make contact with the conductive coating layer and the ground portion with reliability.

According to the electronic apparatus having an antistatic function of aspect 3, in the electronic apparatus having an antistatic function according to aspect 2, there is formed, on the rear surface of the nameplate, a recess for accommodating the bent portion elastically deformed. Thus, the bent portion pinched between the decorative panel and the nameplate is accommodated in the recess, thereby making it possible to prevent the nameplate from being lifted from the decorative panel.

According to the electronic apparatus having an antistatic function of aspect 4, in the electronic apparatus having an antistatic function according to any one of aspects 1 through 3, a mounting boss is integrally formed on the nameplate, and a mounting hole corresponding to the mounting boss is formed in the decorative panel. Thus, the nameplate is fixed to the decorative panel by the mounting boss of the nameplate, thereby making it possible to fix the connecting member to the decorative panel with simplicity and reliability.

What is claimed is:

1. An electronic apparatus having an antistatic function, comprising:
a decorative panel which is placed at a front surface of an enclosure, with a conductive coating layer applied to at least a part of a surface of the decorative panel;
a nameplate which is fixed to a front surface of the conductive coating layer;
a ground portion which is provided in the enclosure; and
a connecting member with which the conductive coating layer makes electric contact with the ground portion,
wherein the connecting member is provided with a mounting portion and a contact portion, the mounting portion being in contact with the conductive coating layer and pinched between the decorative panel and the nameplate, the contact portion extending through the decorative panel from the mounting portion and making contact with the ground portion.

2. The electronic apparatus having an antistatic function according to claim 1, wherein the connecting member has flexibility, and the connecting member is provided with a bent portion as the mounting portion and the contact portion, the bent portion being pinched between the decorative panel and the nameplate and elastically deformed, the contact portion extending from the bent portion and making elastic contact with the ground portion.

3. The electronic apparatus having an antistatic function according to claim 2, wherein there is formed, on the rear surface of the nameplate, a recess for accommodating the bent portion elastically deformed.

4. The electronic apparatus having an antistatic function according to claim 1, wherein a mounting boss is integrally formed on the nameplate, and a mounting hole corresponding to the mounting boss is formed in the decorative panel.

5. The electronic apparatus having an antistatic function according to claim 2, wherein a mounting boss is integrally formed on the nameplate, and a mounting hole corresponding to the mounting boss is formed in the decorative panel.

6. The electronic apparatus having an antistatic function according to claim 3, wherein a mounting boss is integrally formed on the nameplate, and a mounting hole corresponding to the mounting boss is formed in the decorative panel.
